(19) United States
(12) Patent Application Publication
(10) Pub. No.: US 2008/0123232 A1
(43) Pub. Date: May 29, 2008

(54) Bi-directional transient blocking unit having a dual-gate transistor

(76) Inventors: Richard A. Harris, Karana Downs (AU); Mohamed N. Darwish, Campbell, CA (US)

Correspondence Address: LUMEN PATENT FIRM, INC., 2345 YALE STREET, SECOND FLOOR, PALO ALTO, CA, 94306, US

(21) Appl. No.: 11/986,679

(22) Filed: Nov. 21, 2007

Related U.S. Application Data
(60) Provisional application No. 60/860,528, filed on Nov. 21, 2006.

(51) Int. Cl. H02H 9/00

(52) U.S. Cl. 361/56

(57) ABSTRACT

An improved bi-directional transient blocking unit (TBU) is provided having a dual-gate central transistor. The gates of the central transistor are connected to the rest of the TBU such that high voltages can only appear between a gate and the central transistor terminal further from that gate. In this manner, the total device size required to provide a given breakdown voltage can be significantly reduced compared to a conventional symmetric lateral transistor having a single gates.

### CROSS REFERENCE TO RELATED APPLICATION

This application claims the benefit of U.S. provisional patent application 60/860,528, filed on Nov. 21, 2006, entitled “Dual gate GaN transient blocking units”, and hereby incorporated by reference in its entirety.

### FIELD OF THE INVENTION

This invention relates to suppression of electrical transients.

### BACKGROUND

It has long been known that electrical circuits and devices can be damaged by electrical transients at their inputs. Accordingly, transient suppression has been extensively investigated, and various approaches have been developed to date. One such approach is the use of a transient blocking unit (TBU), which is an arrangement of two or more normally-on transistors configured to switch off current flow in response to an over-voltage or over-current condition. One early reference describing TBUs is U.S. Pat. No. 5,742,463, by Richard A. Harris. TBUs are placed in series with the load being protected.

FIG. 1 shows an example of a prior art transient blocking unit. In this example, an electrical load 104 is connected to an electrical source 102 via a TBU circuit including transistors Q1, Q2, and Q3. Operation of the example of FIG. 1 depends on the polarity of I_{TBU}. For one polarity (e.g., positive), transistors Q1 and Q3 provide transient blocking, while for the other polarity (e.g., negative), transistors Q2 and Q3 provide transient blocking. For a current polarity where Q1 and Q3 are the relevant transistors, passage of I_{TBU} through Q1 and Q3 generates gate voltages at Q1 and Q3 that tend to turn both transistors off. If I_{TBU} exceeds a predetermined threshold, the positive feedback inherent in this arrangement acts to rapidly switch the TBU off, thereby protecting load 104 from an over-voltage or over-current condition. For the other current polarity, transistors Q2 and Q3 cooperate in the same way to provide transient blocking.

In many cases of interest, it is desirable for TBUs to be able to withstand high voltages in the current blocking state. One known configuration is where transistors Q1 and Q2 on FIG. 1 are high voltage transistors, and Q3 is a low voltage transistor. However, the cost of such TBUs tends to be significantly driven by the cost of the high voltage TBU transistors. Accordingly, it would be an advance in the art to provide high voltage TBUs having improved cost-effectiveness.

### SUMMARY

An improved bi-directional TBU is provided having a dual-gate central transistor. The gates of the central transistor are connected to the rest of the TBU such that high voltages can only appear between a gate and the central transistor terminal further from that gate. In this manner, the total device size required to provide a given breakdown voltage can be significantly reduced compared to a conventional symmetric lateral transistor having a single gate.

### BRIEF DESCRIPTION OF THE DRAWINGS

FIG. 1 shows a prior art TBU.

FIG. 2 shows an illustrative transistor device geometry.

FIG. 3a shows a TBU according to an embodiment of the invention.

FIG. 3b shows an illustrative transistor device geometry suitable for use in embodiments of the invention.

FIG. 3c shows an exemplary device structure corresponding to the embodiment of FIG. 3a.

FIG. 4a shows dual gate geometry corresponding to the embodiment of FIG. 3a.

FIG. 4b shows a connection of a dual gate transistor that is not suitable for practicing the invention.

FIG. 5 shows a TBU according to a preferred embodiment of the invention.

### DETAILED DESCRIPTION

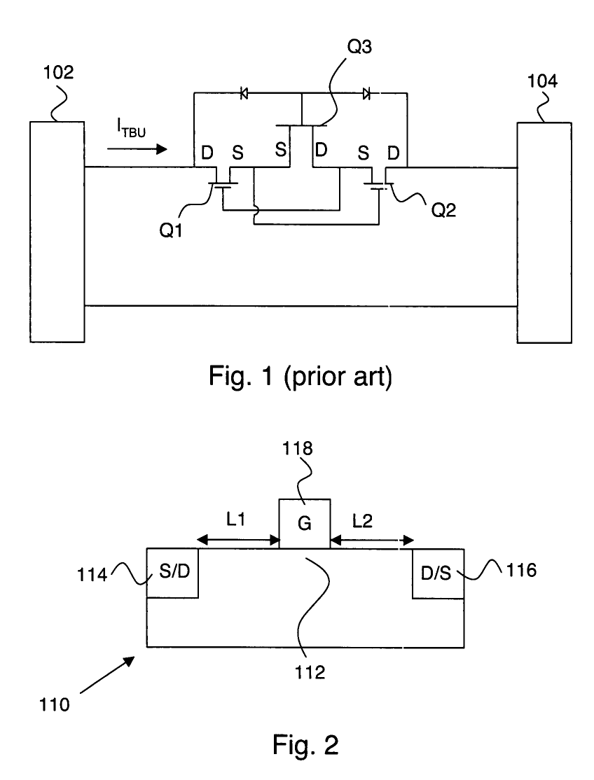

In order to better appreciate the present invention, it is helpful to consider the implications of designing the circuit of FIG. 1 to operate at high voltages by having Q3 be a high voltage (HV) transistor and Q1 and Q2 be low voltage transistors. In such a situation, Q3 would need to have a high breakdown voltage between gate and source for one polarity of I_{TBU} and it would also need to have a high breakdown voltage between gate and drain for the other polarity of I_{TBU}. More briefly, Q3 would need to have substantially symmetric breakdown voltages from its terminals (i.e., source or drain) to its gate.

Such symmetry of breakdown voltages is not often encountered in practice. Many high voltage transistors have a vertical geometry, where it is difficult or even impossible to design for symmetric breakdown voltages. In lateral device designs, it is easier to provide symmetric breakdown voltages, but the resulting designs tend to lead to costly devices.

This issue can be appreciated in connection with FIG. 2, which shows an illustrative lateral transistor device geometry. A transistor 110 has a source (or drain) 114, a drain (or source) 116, and a gate 118. Terminals 114 and 116 act as source and drain respectively, or as drain and source respectively, depending on applied voltage. The transistor operates by controlling flow of a flow of current between source 114 and drain 116 in a channel 112. A substantial gate to drain separation L1 is required for the device of FIG. 2 to have a high gate to drain breakdown voltage when terminal 114 acts as the drain. Similarly, a substantial gate to drain separation L2 is required for the device of FIG. 2 to have a high gate to drain breakdown voltage when terminal 116 acts as the drain. Thus the total channel length must be at least L1+L2, which tends to make the device of FIG. 2 undesirably large and expensive.

This issue of large device size is one of the main reasons that known high voltage TBU circuits tend to have the two outer transistors (e.g., Q1 and Q2 on FIG. 1) being high voltage devices, as opposed to the apparently simpler approach of having only the center transistor be a high voltage device. The outer transistors of such a conventional HV TBU do not need to have symmetric breakdown voltages, so conventional HV design approaches are applicable (e.g., vertical transistors).

However, it is possible to significantly alleviate the issue of large device size for a center HV transistor in a TBU by exploiting the following property of the TBU application: it is not required for the center transistor in a TBU to simultaneously provide high breakdown voltages between the gate and both other terminals T1 and T2. Instead, at some times (i.e., when T1 is acting as the drain) a high gate to T1 breakdown voltage is needed, and at other times (i.e., when T2 is acting as the drain), a high gate to T2 breakdown voltage is needed, depending on the polarity of the transient being blocked.

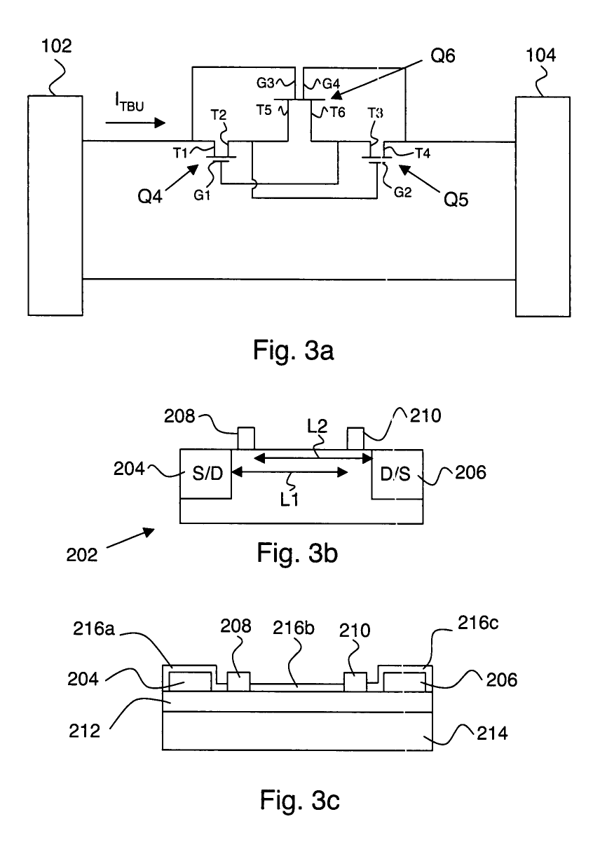

FIG. 3a shows a TBU according to an embodiment of the invention. A key aspect of this example is transistor Q6 being a dual-gate transistor and having gates G3 and G4. Since practice of the invention does not depend critically on the difference between source and drain, the drain/source terminals of the transistors are labeled as follows: transistor Q4 has terminals T1 and T2, transistor Q5 has terminals T3 and T4, and transistor Q6 has terminals T5 and T6. Transistors Q4 and Q5 have gates G1 and G2 respectively. Transistors Q4, Q5, and Q6 are all depletion mode transistors. Gate G1 controls a first current between terminals T1 and T2. Gate G2 controls a second current between terminals T3 and T4. Gates G3 and G4 are independent and both control a third current between terminals T5 and T6.

Terminal T2 is connected to T5, and T6 is connected to T3, so the three transistors are connected in series. The gate connections are as follows: G1 is connected to T3, G2 is connected to T2, G3 is connected to T1, and G4 is connected to T4. Terminals T1 and T4 are the input/output terminals of the TBU, which provides an automatic shut-off function of a controllable current from T1 to T4 responsive to an over-voltage or over-current condition. The TBU is thereby capable of protecting a load 104 from over-voltage or over-current conditions.

The significance of this example can be better appreciated in connection with FIG. 3b, which shows an illustrative transistor device geometry corresponding to the embodiment of FIG. 3a. Here transistor 202 has a source/drain 204, a drain/source 206, and two gates 208 and 210. In cases where terminal 206 acts as the drain, gate 208 should be the relevant gate, and L2 is the relevant gate to drain distance. In cases where terminal 204 acts as the drain, gate 210 should be the relevant gate, and L1 is the relevant gate to drain distance. In this manner, the total channel length required to provide large separation between gate and drain can be substantially reduced in a symmetric device geometry where source and drain are reversible. More specifically, the distances L1 and L2 on FIG. 3b overlap, in sharp contrast to the situation of FIG. 2, where there is no overlap of the relevant separations.

Suppose that a gate to terminal separation of at least Lₘᵢₙ is required to provide a specified breakdown voltage. With the arrangement of FIG. 2, the required total channel length of the device would be at least 2Lₘᵢₙ. With the improved arrangement of FIG. 3, the required total channel length of the device would be slightly more than Lₘᵢₙ. Reducing the channel length of a HV device by about a factor of two in this manner can provide significant cost advantages.

In TBUs according to embodiments of the invention, it is preferred for the center transistor to be a high voltage transistor (e.g., breakdown voltage >50 V, more preferably breakdown voltage >100 V) as opposed to a low voltage device. It is further preferred for the center transistor to be a GaN high voltage transistor, such as a high electron mobility transistor (HEMT) or a metal-semiconductor field effect transistor (MESFET). The GaN material system is preferred for the center transistor, because it is difficult/costly to fabricate high performance HV lateral FETs in Silicon. For example, providing breakdown voltages above 50 V in a Silicon JFET tends to be highly cost ineffective. However, practice of the invention does not depend critically on material system or transistor type.

FIG. 3c shows an exemplary GaN HEMT device structure suitable for use in embodiments of the invention. In this example, source and drain 204 and 206, as well as gates 208 and 210 are disposed on an n-type AlGaN layer 212, which in turn is disposed on an undoped GaN substrate 214. Passivation layers 216a-c protect AlGaN layer 212. Dual gate transistors (e.g., as described above) are known in the art in relation to applications other than TBU circuits. For example, in U.S. Pat. No. 5,821,813 and in U.S. Pat. No. 6,801,088, one gate is used a signal input and the other gate is employed as a bias input. Use of one gate for signal and the other gate for bias is similar to the arrangement of a pentode tube, in which the gates are located at the same end of the device, and cathode and anode (corresponding to source and drain) are not reversible.

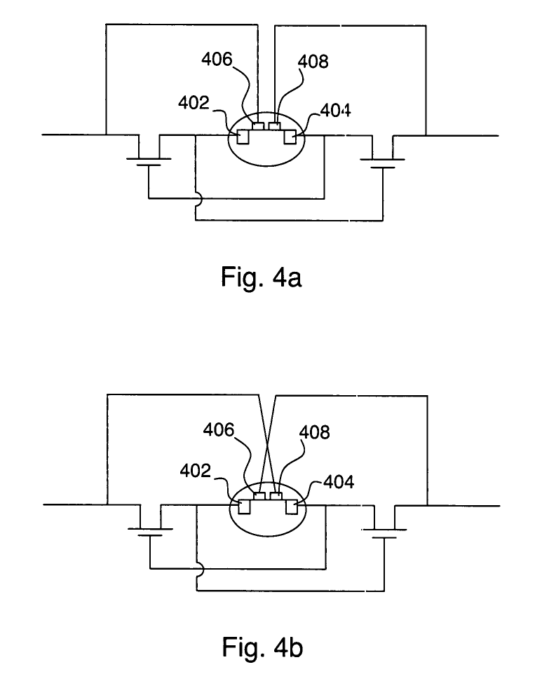

It is important in TBUs according to embodiments of the invention to connect the gates of the dual-gate transistor correctly to the remainder of the TBU circuit. FIG. 4a shows the correct connections. Here the terminals of the dual-gate transistor are shown as 402 and 404, while the two gates are shown as 406 and 408. Assuming the outer transistors of the TBU are low voltage devices, it follows that source/drain 402 and gate 406 have roughly similar voltages, as do source/drain 404 and gate 408. When the TBU is blocking high voltages, there is a high voltage between terminals 402 and 404. Thus there can be high voltage between gate 406 and terminal 404, and between gate 408 and terminal 402 (i.e., between a gate and its “far” terminal), but high voltage can never appear between gate 406 and terminal 402, or between gate 408 and terminal 404 (i.e., between a gate and its “near” terminal). This behavior is just right for exploiting the device geometry of FIG. 3b to reduce device size while providing high and symmetric breakdown voltages.

In contrast, FIG. 4b shows incorrect connections. Following the above line of reasoning, it is clear that with incorrect connections as on FIG. 4b, the high voltages appear between a gate and its corresponding “near” terminal. In this situation, no benefit is obtained from use of the dual-gate transistor.

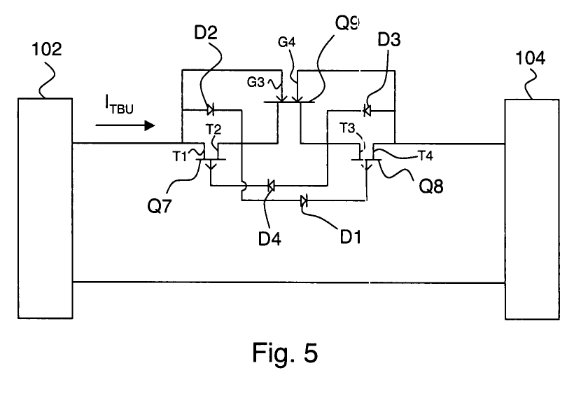

Therefore, the order of the gates as shown on the schematic of FIG. 3a is significant in the following sense: gate G3 is the gate of transistor Q6 that is closer to T5 than to T6 (as measured along the channel of Q6), and gate G4 is the gate of transistor Q6 that is closer to T6 than to T5, as suggested by the way the schematic is drawn. The schematic of FIG. 5 also follows this same convention.

FIG. 5 shows a TBU according to a preferred embodiment of the invention. In this example, Q7 and Q8 are low voltage p-channel depletion mode transistors, and Q9 is a high voltage, dual-gate depletion mode n-channel transistor, preferably a GaN HEMT or MESFET as described above. Having the HV device being n-channel is preferred because n-channel devices tend to provide better performance than p-channel devices. In this example, for positive I_{TBU} (i.e., in direction of I_{TBU} arrow), transistors Q8 and Q9 cooperate to provide transient blocking. For negative I_{TBU}, transistors Q7 and Q9 cooperate to provide transient blocking.

More specifically, for negative I_{TBU} exceeding a predetermined first threshold, a voltage between terminals T1 and T2 provides a voltage at G3 tending to switch off Q9, which then acts to switch off Q7, thereby shutting off the TBU. Similarly, for positive I_{TBU} exceeding a predetermined second threshold, a voltage between terminals T3 and T4 provides a voltage at G4 tending to switch off Q9, which then acts to switch off Q8, thereby shutting off the TBU.

Diodes D1 and D4 act to block current flow to or from the gates of Q7 and Q8. In some cases, the voltage handling capability of the gates of Q7 and Q8 may be insufficient to handle the high voltage developed across Q9. In such cases, resistance can be included in series with diodes D1 and D4 (or as a replacement to the diodes) to ensure the bypass current generated by this high voltage is limited to a level that the gates of Q7 and Q8 can handle. Also, in some cases, the junction voltages of Q7 and Q8 can be such that it is not necessary to provide diodes D1 and D4 to prevent current flow to or from the gates of Q7 and Q8.

In some cases, transistors Q7 and Q8 may exhibit current collapse, which is a transient decrease in channel conductivity responsive to a high applied voltage. For example, GaN transistors are prone to exhibit current collapse. In such cases, it is preferable to add optional diodes D2 and D3 as shown, which serve to protect Q7 and Q8 from damage cause by high reverse voltages. More specifically, Q7 is relevant for blocking negative transients, so its corresponding diode D2 permits the flow of positive current (i.e., build-up of high reverse voltage is prevented). Similarly, Q8 is relevant for blocking positive transients, so its corresponding diode D3 permits the flow of negative current. Here also, build-up of high reverse voltage is prevented by the diode shunt.

In some cases, resistors may be placed in series with one or more of diodes D1-D4 in order to adjust the biasing of the transistors. Such bias adjustment is within the skill of an ordinary art worker.

1. A transient blocking unit (TBU) comprising:
a first depletion mode transistor having a first gate G1 controlling a first current between terminals T1 and T2;
a second depletion mode transistor having a second gate G2 controlling a second current between terminals T3 and T4;
a third depletion mode transistor having independent third and fourth gates G3 and G4 both controlling a third current between terminals T5 and T6;
wherein said gates G3 and G4 are disposed along a channel of said third transistor from T5 to T6 such that G3 is closer to T5 than to T6, and such that G4 is closer to T6 than to T5;
wherein T2 is connected to T5 and T6 is connected to T3;
wherein G1 is connected to T3, G2 is connected to T2, G3 is connected to T1, and G4 is connected to T4;
wherein said TBU provides an automatic shut-off function of a controllable current from T1 to T4 responsive to an over-voltage or over-current condition, and is thereby capable of protecting an electrical load connected in series with said TBU from said over-voltage or over-current condition.

2. The transient blocking unit of claim 1, wherein said third transistor comprises a high voltage transistor, and wherein said first and second transistors comprise low voltage transistors.

3. The transient blocking unit of claim 2, wherein said high voltage transistor comprises a GaN high voltage transistor.

4. The transient blocking unit of claim 2, wherein said high voltage transistor comprises a metal-semiconductor field effect transistor or a high electron mobility transistor.

5. The transient blocking unit of claim 1:
wherein, for a first polarity of said controllable current exceeding a first predetermined current threshold, a voltage between terminals T1 and T2 provides a voltage at G3 tending to switch off said third transistor, which then acts to switch off said first transistor, thereby shutting off flow of said controllable current;
wherein, for a second polarity of said controllable current opposite to said first polarity and exceeding a second predetermined current threshold, a voltage between terminals T3 and T4 provides a voltage at G4 tending to switch off said third transistor, which then acts to switch off said second transistor, thereby shutting off flow of said controllable current.

6. The transient blocking unit of claim 5, further comprising a diode connected in parallel with said first transistor and disposed to permit current flow having said second polarity.

7. The transient blocking unit of claim 5, further comprising a diode connected in parallel with said second transistor and disposed to permit current flow having said first polarity.

8. The transient blocking unit of claim 1, wherein a separation between said gate G3 and said terminal T5 is substantially the same as a separation between said gate G4 and said terminal T6, whereby said third depletion mode transistor has symmetrically disposed gates.
